(19) United States
(12) Patent Application Publication
(10) Pub. No.: US 2026/0158778 A1
(43) Pub. Date: Jun. 11, 2026

(54) PRINTING PLATE FOR TRANSFERRING AN INK, PRINTING SYSTEM, AND METHOD FOR PRINTING ON A CONTAINER

(71) Applicant: ARDAGH METAL PACKAGING EUROPE GMBH, Zug (CH)

(72) Inventors: Jiamin Le, Bonn (DE); Oscar BROUWER, Braband Zeeland (NL)

(21) Appl. No.: 18/707,144

(22) PCT Filed: Oct. 25, 2022
(86) PCT No.: PCT/EP2022/079802

§ 371 Date: May 2, 2024

(30) Foreign Application Priority Data
Nov. 3, 2021 (DE) 10 2021 128 652.2

(51) Int. Cl. B41F 17/22; B41F 5/24

(52) U.S. Cl. CPC B41F 17/22; B41F 5/24

(57) ABSTRACT

Printing plate (1) for transferring a printing ink (2) to a rubber blanket (3) for printing on an object surface (4), the printing plate (1) having a plurality of elevations (5) which, starting from a base surface (6) of the printing plate (1), extend in a direction (7) orthogonal to the base surface (6), each elevation (5) having a printing surface (8) to which the printing ink (2) can be applied, with which the printing plate (1) contacts the rubber blanket (3) for transferring the printing ink (2), wherein at least one of the printing surfaces (8) comprises a first region (9) with a flat surface (10) and at least one second region (11) with a concave surface (10), wherein the first region (9) completely encloses the at least one second region (11).

Printing system (19) and method for printing an object (20).

The present invention relates to a printing plate for transferring a printing ink to a rubber blanket for printing an object surface, a printing system, at least comprising the printing plate and a rubber blanket, and a method for printing a container with the printing system.

The invention is used in particular for printing a printed image on a container, in particular an essentially cylindrical container, such as a beverage can, with an object surface designed as a container wall, which consists of metal and/or glass or comprises metal and/or glass.

Containers of the type mentioned at the beginning are known. The containers are used to contain drinks, food or other products. A container wall, and possibly also a container base and/or a container lid, can be made of metal and/or glass or comprise these materials. A beverage can, for example, is preferably made in two parts with a deep-drawn can body with a base and a can wall, whereby a lid is crimped onto the open end of the can body after filling. Beverage cans can also be made in three parts with a preferably welded can wall and a can base attached to it as well as a can lid applied after filling.

For such containers, the letterpress process is usually used as dry offset letterpress process. In such a process the printing ink is transferred from a letterpress form, in this case the printing plate, to the container wall via an intermediate rubber carrier, in this case the rubber blanket. The ink is transferred via raised structures on the printing plate, with which the rubber blanket is contacted.

In the letterpress process, one printing ink is applied to the printing plate at a time. The printing plate is usually arranged on a rotating printing cylinder. The printing inks are then transferred from the printing plates to a rubber blanket (also known as a rubber plate or rubber cylinder), which is usually arranged on a rotating cylinder to form a print image or pattern. The inks arranged in the pattern or print image are then transferred from the rubber blanket to the object to be printed, in this case in particular a container, for example a cylindrical container such as a beverage can. The combination of rubber blanket and printing plate can also be referred to as a printing system.

There is a constant need to improve the print image on such containers. In particular, the color intensity should be maximized. The colour intensity can be achieved, for example, by applying a larger amount of ink to the printing plate. However, this leads to the problem of dot growth, i.e. the increasing expansion of the ink transferred in dots from the printing plate via the rubber blanket to the container. The dot growth leads to a visible deterioration of the printed image produced on the container, e.g. with regard to the mixing of different colors or other color tones/altered color tones).

The object of the invention is to at least partially solve the problems existing with reference to the prior art and, in particular, to provide a printing plate with which the quality of a printed image can be further improved.

These objects are solved with a printing plate according to the features of claim 1, with a printing system according to the features of claim 8 and with a method according to the features of claim 10. Further advantageous embodiments of the invention are given in the dependent claims. It should be noted that the features listed individually in the dependent claims can be combined with one another in a technologically meaningful way and define further embodiments of the invention. In addition, the features specified in the claims are further specified and explained in the description, whereby further preferred embodiments of the invention are shown.

A printing plate for transferring a printing ink to a rubber blanket for printing on an object surface is proposed. The printing plate has a plurality of elevations which extend from a base surface of the printing plate in a direction orthogonal to the base surface. Each elevation has a printing surface to which the printing ink can be applied. The printing plate can contact the rubber blanket with the printing surface to transfer the printing ink. At least one of the printing surfaces comprises a first area with a flat surface and at least one second area with a concave surface, wherein the first area completely surrounds the at least one second area.

In particular, the printing plate is part of a printing system for a letterpress offset process. In this process, a printing ink is transferred from a letterpress form, in this case the printing plate, via an intermediate rubber carrier, in this case the rubber blanket, to an object, e.g. a container wall of a container, in particular a beverage can. The ink is transferred via the printing surfaces of the elevations of the printing plate, with which the rubber blanket is contacted. The ink is therefore transferred to the rubber blanket and from there to the object.

A printing plate for letterpress printing using the dry offset letterpress process is therefore proposed.

The print image produced is formed in particular by grid points, with each grid point being formed by a printing surface of an elevation. The grid points or printing surface can be spaced at different or equal distances from each other. The grid points or printing surfaces can have different shapes, e.g. circular, square, rectangular, star-shaped, etc.

In particular, the printing plate has differently designed elevations. In particular, at least two elevations are designed differently from one another.

In particular, a first subset of the plurality of elevations of the printing plate is designed differently from a second subset. The differences may include, for example, the distances between the printing surfaces, the shape of the printing surface and/or the indentation, the size ratios of the first area and the second area, the width or depth of the concave surfaces or the indentation, the shape of the concave surfaces or the indentation, the presence of a second area or flat printing surfaces (without indentation), etc.

It is known that the printing surfaces of the elevations are flat, i.e. the elevation has a flat surface at the end facing away from the base surface. In particular, this flat surface runs parallel to the base surface. The printing surface forms a grid point of the printed image to be produced.

It is now proposed that an indentation is provided within the otherwise flat printing surface, designated here by the second area. In particular, this indentation can accommodate a larger amount of ink. The ink can therefore be better distributed in the indentation and then transferred to an object. This means that a higher color intensity can be achieved with less (or an equally large) amount of ink. The color intensity present in this grid point of the printed image can thus be increased. It has been shown that the arrangement of the second area within the first area, which completely surrounds the second area, at least largely prevents the dot/point (the grid point) created by the printing surface on the object surface from growing.

In particular, the at least one second area extends over at most 80%, in particular at most 70%, preferably at most 60%, particularly preferably at most 50% of the printing surface of the at least one elevation. In particular, the second area extends over at least 1%, preferably at least 5% or at least 10% of the printing surface.

The size of the respective area is determined in particular by the projection of the area into the plane of the surface of the first area.

In particular, the second area is centered relative to the first area.

In particular, the boundary line between the first area and the second area runs parallel to an outer boundary line of the first area, i.e. the printing surface. In particular, the outer shape of the second area then corresponds to the outer shape of the printing surface.

In particular, the shape of the second area can deviate from the shape of the printing surface. In particular, a center of gravity of the second area and a center of gravity of the first area lie on top of each other.

In particular, the elevations are arranged on the printing plate with a resolution of 10 to 10,000 elevations per square centimeter and each elevation forms a grid point. The elevations of the printing plate can be of the same type or different from one another. The printing surfaces of the elevations are each arranged at an equal spacing from the base surface of the printing plates. In particular, the printing plate has an overall thickness that corresponds to this spacing.

In particular, each elevation extends from a base surface of the printing plate along the direction orthogonal to the base surface up to the printing surface. The section of the base surface covered by each elevation, referred to below as the base surface section, can be the same size or can have different sizes for each elevation of the printing plate.

Starting from the respective covered base surface section, each elevation extends in particular increasingly tapering towards the printing surface. If the printing surfaces of elevations with the same base surface sections of the elevations are of different sizes, the elevations have side walls that are inclined differently to the orthogonal direction.

In particular, a halftone value denotes the proportion of the printing surface on a base surface section covered by the elevation forming the printing surface. In particular, the halftone value is between 2% and 80%, preferably between 4% and 65%. In particular, the halftone value of the at least one elevation that has the second area is between 2% and 80%, preferably between 4% and 65%.

In particular, each elevation that has a halftone value of at least 65%, preferably at least 70%, particularly preferably at least 80%, has no second area, but only a printing surface with an exclusively flat surface.

In particular, the at least one second area, starting from the flat surface of the first area, has a maximum depth of between at least 1 μm and at most 100 μm and forms a cavity between a plane of the surface of the first area and the depth. The greatest depth is in particular at least 5 μm, especially preferably 10 μm. The greatest depth is in particular at most 80 μm, particularly preferably at most 50 μm or even at most 35 μm.

The depth extends in particular starting from a plane of the surface of the first area along the orthogonal direction towards the base surface of the base plate. The cavity is formed between this plane, in which the flat surface of the first area extends, and the depth.

The cavity serves in particular as a reservoir for the printing ink. Preferably, the reservoir is refilled with ink after each contact between the elevation and the rubber blanket.

In particular, the cavity has a first cross-sectional area in the plane of the surface of the first area. In particular, the cavity has a second cross-sectional area arranged parallel to the first cross-sectional area along the orthogonal direction (up to the greatest depth). At least one second cross-sectional area arranged at a distance from the plane and parallel to the first cross-sectional area is smaller, the same size or larger than the first cross-sectional area. In particular, all second cross-sectional areas are smaller, the same size or larger than the first cross-sectional area. The shape of the cavity can be used in particular to influence the transition of the ink onto the rubber blanket. Furthermore, the shape of the cavity (and the greatest depth) can influence the volume of the cavity and thus the amount of ink transferred to the rubber blanket.

In particular, there is a valley (an intermediate depth) between two printing surfaces or elevations arranged adjacent to each other, the deepest point of which is arranged along the orthogonal direction at a distance (i.e. the depth of the intermediate depth) of at least 50 μm from the plane of the surface of the first area. During operation of the printing plate or printing system, the ink is not applied to this valley between the printing surfaces or the elevations, or it is not used to transfer ink to the rubber blanket.

In particular, the plurality of elevations is at least partially made of an elastically deformable plastic, preferably an elastomer or a photopolymer.

The use of an elastically deformable plastic for the printing plate or the elevations has the particular advantage that the resolution and contrast of the resulting printed image can be improved. The elastically deformable plastic, in particular the elastomer or the photopolymer, can compensate the pressure between a printing cylinder, on which the printing plate is usually arranged, and a rubber blanket, to which the printing ink is transferred from the printing plate, better than a non-deformable or less deformable printing plate.

The use of elastically deformable plastic can, in particular, enable a higher resolution with correspondingly sharper and better defined edges of the printed image or the individual grid points.

A further advantage results from the simpler and more cost-effective processing of the elastically deformable plastic, in particular the elastomer, for example by laser processing or by UV irradiation, whereby preferred designs of the printed surfaces can be realized. In particular, an elastomer can be processed with laser radiation, a photopolymer with laser radiation or UV radiation.

A printing system is further proposed, comprising at least the described printing plate and a rubber blanket for receiving the printing ink from the printing plate and for transferring the printing ink to an object surface of an object to be printed. The printing system is intended in particular for carrying out a letterpress offset process (dry offset letterpress process).

In particular, the printing plate and the rubber blanket are each roller-shaped or cylindrical, i.e. designed as rollers, and contact each other via their respective cylindrical contact surfaces. In particular, the rubber blanket rolls on the printing plate on the one hand and on the object or container on the other, so that with one revolution of the rubber blanket, each surface section of the rubber blanket has picked up ink from the printing plate once and has transferred this ink to the surface of an object.

A method for printing an object with the described printing system is further proposed, the method comprising at least the following steps:
a) providing an object with an object surface and arranging the container in the printing system;
b) printing the object surface with printing ink, which is transferred from the rubber blanket to the object surface starting from the printing plate, wherein the printing ink is transferred at least from the at least one printing area, comprising the first area and the at least one second area, to the rubber blanket.

In particular, spot colors (colors produced by mixing) or process colors (colors consisting of the standard process colors CMYK, i.e. cyan, magenta, yellow and contrast or black), or even a combination of spot colors and process colors, can be used in the process.

In particular, the printed image can consist at least partially of grid points, each of which is formed by process colors/special colors. The respective desired color on the printed object can be generated from the arrangement of a plurality of grid points of different process colors/special colors.

In particular, containers, preferably beverage cans, are used as the object to be printed. These cans can be made of aluminum or aluminum alloys or steel, in particular tinplate. The containers can also be provided with various paints and/or coatings, which can be located above and/or below the described print image. The printed image is preferably applied to a white background, in particular if a container wall is a container wall made of steel or has steel.

The object surface or container wall is understood in particular to be the outer shell surface of an essentially cylindrical container body. In addition, the container wall can also comprise the entire object surface, in particular the entire outer object surface, of the container, i.e. also its base or its lid.

Furthermore, it may be provided that the container has a substrate coating under the printed image. This substrate coating can be used, for example, to provide a uniform background color for the printed image. The background coating can be white, for example.

In particular, an object or container, especially a beverage can, is printed with a printed image at the speed of the usual manufacturing or production process for containers or beverage cans, e.g. at a speed of approx. 2,000 containers per minute.

With the proposed printing plate or printing system and method, printing ink in particular can be saved compared to known printing processes. Furthermore, the contrast of the printed image can be improved, especially on metallic containers. In particular, an increased color intensity can be achieved. In particular, the merging of printing inks in adjacent grid points/dots can be prevented. Grid point/dot growth, i.e. an increase in the size of the grid point in the printed image compared to the printing surface, can be prevented or more strongly restricted.

The remarks on the printing plate apply in particular equally to the printing system and the method and vice versa.

The use of indefinite articles (“a”, “an”), in particular in the claims and the description reproducing them, is to be understood as such and not as a number word. Accordingly, terms or components introduced thereby are to be understood as being present at least once and, in particular, as being present more than once.

As a precaution, it should be noted that the number words used here (“first”, “second”, . . . ) primarily serve (only) to differentiate between several objects, quantities or processes of the same type, i.e. in particular they do not necessarily specify any dependency and/or sequence of these objects, quantities or processes in relation to one another. If a dependency and/or sequence is required, this is explicitly stated here or is obvious to the person skilled in the art when studying the specific embodiment described. Insofar as a component may occur more than once (“at least one”), the description of one of these components may apply equally to all or some of the plurality of these components, but this is not mandatory.

The invention and the technical context are explained in more detail below with the aid of the accompanying figures. It should be noted that the invention is not intended to be limited by the embodiments given. In particular, unless explicitly shown otherwise, it is also possible to extract partial aspects of the matters explained in the figures and to combine them with other components and findings from the present description. In particular, it should be noted that the figures and in particular the proportions shown are only schematic. The figures show

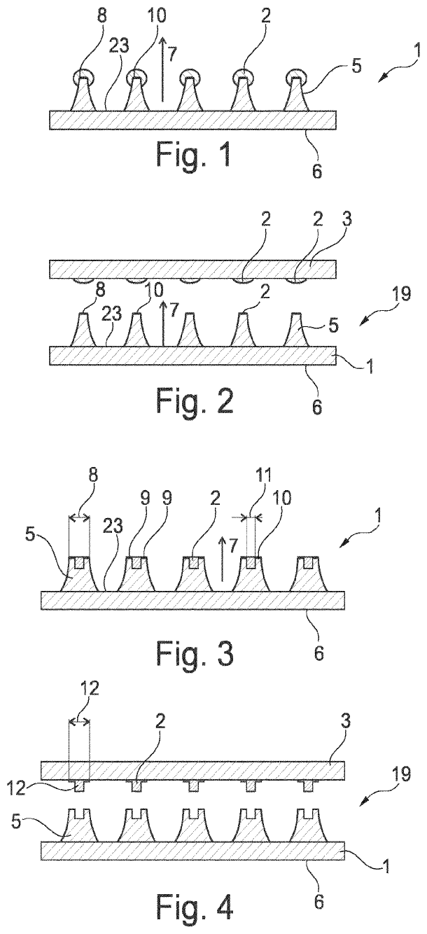

FIG. 1: a known printing plate in a side view in section;

FIG. 2: a printing system with the printing plate according to FIG. 1 in a side view in section;

FIG. 3: a printing plate in a side view in section;

FIG. 4: a printing system with the printing plate according to FIG. 3 in a side view in section;

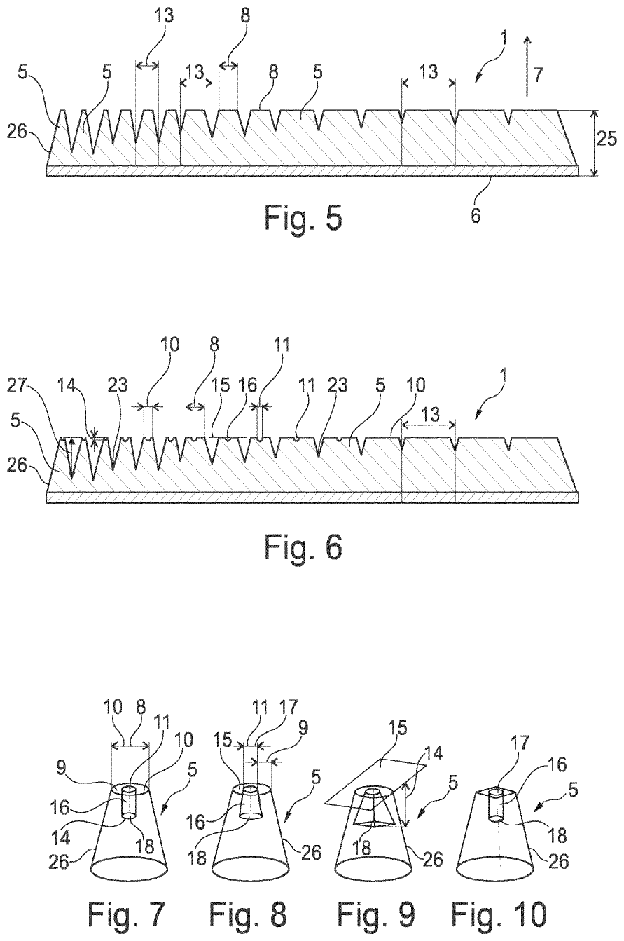

FIG. 5: a known printing plate with different elevations in a side view in section;

FIG. 6: a printing plate with different elevations in a side view in section;

FIG. 7: a first embodiment of an elevation in a perspective view;

FIG. 8: a second embodiment of an elevation in a perspective view;

FIG. 9: a third embodiment of an elevation in a perspective view;

FIG. 10: a fourth embodiment of an elevation in a perspective view;

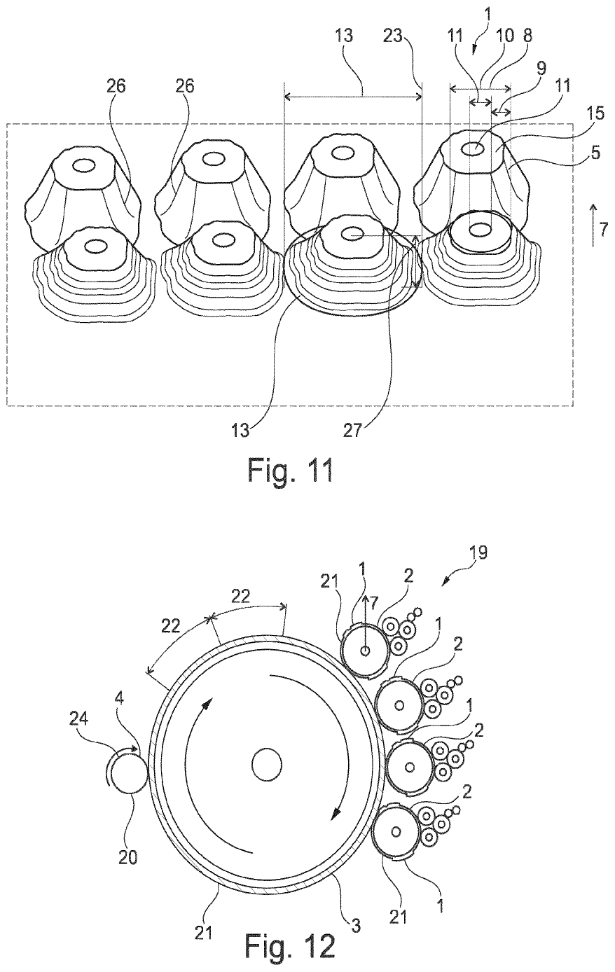

FIG. 11: a printing plate in a perspective view; and

FIG. 12: a printing system with different printing inks in a side view in section.

FIG. 1 shows a known printing plate 1 in a side view in section. FIG. 2 shows a printing system 19 with the printing plate 1 according to FIG. 1 in a side view in section. FIGS. 1 and 2 are described together below.

The printing system 19 comprises the printing plate 1 and a rubber blanket 3 for receiving the printing ink 2 from the printing plate 1 and for transferring the printing ink 2 to an object surface 4 of an object 20 to be printed (see FIG. 12). The printing plate 1 has a plurality of similarly designed elevations 5, which extend from a base surface 6 of the printing plate 1 in a direction 7 orthogonal to the base surface 6. Each elevation 5 has a printing surface 8 to which the printing ink 2 is applied. The printing plate 1 can contact the rubber blanket 3 with the printing surface 8 to transfer the printing ink 2. The printing surfaces 8 have a flat surface 10. A valley 23, in which no printing ink 2 is arranged during printing, is arranged between each of the elevations arranged adjacent to one another.

FIG. 3 shows a side view of a printing plate 1 in section. FIG. 4 shows a printing system 19 with the printing plate 1 according to FIG. 3 in a sectional side view. FIGS. 3 and 4 are described together below. Reference is made to the comments on FIGS. 1 and 2.

In contrast to the known printing plate 1, the printing surfaces 8 each have an annular first area 9 with a flat surface 10 and a second area 11 with a concave surface 10, whereby the first area 9 completely surrounds the second area 11.

Within the otherwise flat printing surface 8 (see FIGS. 1 and 2), the printing plate 1 according to FIGS. 3 and 4 has an indentation, designated here by the second area 11. This indentation allows a larger amount of ink 2 to be applied. This allows the color intensity present in this grid point 12 of the printed image 24 (here on the rubber blanket 3) to be increased. It has been shown that the arrangement of the second area 11 within the first area 9, which completely surrounds the second area 11, at least largely prevents the dot (the grid point 12) created by the printing surface 8 on the object surface 4 from growing.

FIG. 5 shows a known printing plate 1 with different elevations 5 in a side view in section. FIG. 6 shows a printing plate 1 with different elevations 5 in a side view in section. FIGS. 5 and 6 are described together below. Reference is made to the explanations of FIGS. 1 to 4.

The elevations 5 are each designed differently. The printing surfaces 8 of the elevations 5 are each arranged at an equal spacing 25 from the base surface 6 of the printing plates 1.

Starting from a base surface 6 of the printing plate 1, each elevation 5 extends along the direction 7 orthogonal to the base surface 6 as far as the printing surface 8. The section of the base surface 6 covered by each elevation 5, referred to here as the base surface section 13, is of a different size for each elevation 5 of the printing plate 1.

Starting from the respective covered base surface section 13, each elevation 5 extends increasingly tapering towards the printing surface 8. The elevations 5 have side walls 26 that are inclined at different angles to the orthogonal direction 7.

A halftone value denotes the proportion of the printing surface 8 on a base surface section 13 covered by the elevation 5 forming the printing surface 8. Here, the halftone value of the elevations 5 increases from left to right (i.e. the printing surfaces 8 become larger in each case).

In FIG. 6 it can be seen that each elevation 5, which has a halve tone value of at least 65%, does not have a second area 11, but only a printing surface 8 with an exclusively flat surface 10.

Starting from the flat surface 10 of the first area 9, the second area 11 of each elevation 5 has a maximum depth 14 of between at least 1 μm and at most 100 μm and forms a cavity 16 between a plane 15 of the surface 10 of the first area 9 and the depth 14.

Starting from a plane 15 of the surface 10 of the first region 9, the depth 14 extends along the orthogonal direction 7 towards the base surface 6 of the printing plate 1. The cavity 16 is formed between this plane 15, in which the flat surface 10 of the first area 9 extends, and the depth 14.

The cavity 16 serves as a reservoir for the printing ink 2.

Between two printing surfaces 8 or elevations 5 arranged adjacent to each other, there is in each case a valley 23, the deepest point of which is arranged along the orthogonal direction 7 at a distance 27 from the plane 15 of the surface 10 of the first area 9. This valley 23 between the printing surfaces 8 or the elevations 5 is not currently exposed to the printing ink 2 during operation of the printing plate 1 or the printing system 19, or is not used to transfer printing ink 2 to the rubber blanket 3.

FIG. 7 shows a first embodiment of an elevation 5 in a perspective view. FIG. 8 shows a second embodiment of an elevation 5 in a perspective view. FIG. 9 shows a third embodiment of an elevation 5 in a perspective view. FIG. 10 shows a fourth embodiment of an elevation 5 in a perspective view. FIGS. 7 to 10 are described together below. Reference is made to the comments on FIGS. 3 and 4 and 6.

The elevations 5 shown are designed differently, i.e. they have different shapes, printing surfaces 8, side walls 26, first areas 9 and second areas 11 or depths 14 and cavities 16.

Each cavity 16 has a first cross-sectional area 17 (circular in each case) in the plane 15 of the surface 10 of the first area 9. Each cavity 16 has second cross-sectional surfaces 18 arranged parallel to the first cross-sectional surface 17 along the orthogonal direction 7 and up to the greatest depth 14. The second cross-sectional areas 18 of FIG. 7 and FIG. 10 are each the same size as the respective first cross-sectional area 17. In FIGS. 8 and 9, the second cross-sectional areas 18 are each larger than the respective first cross-sectional area 17. In FIG. 9, at least some of the second cross-sectional areas 18 are quadrangular.

FIG. 11 shows a printing plate 1 in a perspective view. The elevations 5 are each designed in the same way. The printing surfaces 8 of the elevations 5 are each arranged at an equal spacing 25 from the base surface 6 of the printing plates 1.

Starting from a base surface 6 of the printing plate 1, each elevation 5 extends along the direction 7 orthogonal to the base surface 6 as far as the printing surface 8. The section of the base surface 6 covered by each elevation 5, referred to here as the base surface section 13, is of the same size for each elevation 5 of the printing plate 1.

Starting from the respective covered base surface section 13, each elevation 5 extends increasingly tapering towards the printing surface 8. The elevations 5 have side walls 26 inclined to the orthogonal direction 7. The printing surface 8 of each elevation 5 has an annular first area 9 with a flat surface 10 and a second area 11 with a concave surface 10, whereby the first area 9 completely surrounds the second area 11.

Between two printing surfaces 8 or elevations 5 arranged adjacent to each other there is a valley 23, the lowest point of which is arranged along the orthogonal direction 7 at a distance 27 from the plane 15 of the surface 10 of the first region 9. This valley 23 between the printing surfaces 8 and the elevations 5 is not exposed to the printing ink 2 during operation of the printing plate 1 or the printing system 19, or is not used to transfer the printing ink 2 to the rubber blanket 3.

FIG. 12 shows a sectional side view of a printing system 19 with different printing inks 2.

The printing plates 1 and the rubber blanket 3 are each roller-shaped or cylindrical, i.e. designed as rollers, and contact each other via their respective cylindrical contact surfaces 21. The rubber blanket 3 rolls on each printing plate 1 on the one hand and on the object 20 or container on the other, so that with one revolution of the rubber blanket 3, each surface section 22 of the rubber blanket 3 has picked up ink 2 from each printing plate 1 once and transferred this ink 2 to the object surface 4 of an object 20. A plurality of objects 20 are printed with each rotation of the rubber blanket 3. For this purpose, the rubber blanket 3 has a plurality of surface sections 22, with each surface section 22 printing exactly one object 20 with a print image 24. The surface sections 22 are arranged along the circumferential direction, in particular at a distance from one another, so that the successive printing of a plurality of individual containers is made possible.

### LIST OF REFERENCE SYMBOLS

1 printing plate
2 printing ink
3 rubber blanket
4 object surface
5 elevation
6 base surface
7 direction
8 printing surface
9 first area
10 surface
11 second area
12 grid point
13 base area section
14 depth
15 plane
16 cavity
17 first cross-sectional area
18 second cross-sectional area
19 printing system
20 object
21 contact surface
22 surface section
23 valley
24 print image
25 spacing
26 side wall
27 distance

1. A printing plate for transferring a printing ink to a rubber blanket for printing on an object surface, the printing plate having a plurality of elevations which, starting from a base surface of the printing plate, extend in a direction orthogonal to the base surface, each elevation having a printing surface to which the printing ink can be applied, with which the printing plate contacts the rubber blanket for transferring the printing ink, wherein at least one of the printing surfaces comprises a first region with a flat surface and at least one second region with a concave surface, wherein the first region completely encloses the at least one second region.

2. The printing plate according to claim 1, wherein the at least one second region extends over at most 80% of the printing surface.

3. The printing plate according to claim 1, wherein at least two elevations are designed differently from one another.

4. The printing plate according to claim 1, wherein the elevations are arranged on the printing plate with a resolution of 10 to 10,000 elevations per square centimeter and each elevation forms a grid point.

5. The printing plate according to claim 1, wherein a halftone value denotes a proportion of the printing surface on a base surface section covered by the elevation forming the printing surface; wherein the halftone value is between 2% and 80%.

6. The printing plate according to claim 5, wherein the elevations of the printing plate, which have a halftone value of at least 80%, have an exclusively flat surface.

7. The printing plate according to claim 1, wherein the at least one second region, starting from the flat surface of the first region, has a maximum depth of between at least 1 μm and at most 100 μm and forms a cavity between a plane of the surface of the first region and the depth.

8. The printing plate according to claim 7, wherein the cavity in the plane of the surface of the first region has a first cross-sectional area, wherein at least one second cross-sectional area arranged at a distance from the plane towards the depth and parallel to the first cross-sectional area is the same size or larger than the first cross-sectional area.

9. A printing system, at least comprising a printing plate according to claim 1 and a rubber blanket for receiving the printing ink from the printing plate and for transferring the printing ink to an object surface of an object to be printed.

10. The printing system according to claim 9, wherein the printing plate and the rubber blanket are each designed as rollers and make contact via their respective cylindrical contact surfaces.

11. A method for printing an object with a printing system according to claim 9, the method comprising:
providing an object with an object surface and arranging the object in the printing system;
printing the object surface with a printing ink which is transferred from the printing plate by the rubber blanket to the object surface, the printing ink being transferred to the rubber blanket at least from an at least one printing surface on the printing plate, the printing surface comprising a first area and at least one second area.
